(19) United States
(12) Patent Application Publication
(10) Pub. No.: US 2004/0015620 A1
(43) Pub. Date: Jan. 22, 2004

(54) Method for reporting information in a pervasive embedded environment

(75) Inventors: William A. Brown, Raleigh, NC (US); Richard William Muirhead, Tyler, TX (US); Francis Xavier Reddington, Sarasota, FL (US)

Correspondence Address: Darcell Walker, Suite 250, 9301 Southwest Freeway, Houston, TX, 77074, US

(73) Assignee: INTERNATIONAL BUSINESS MACHINES CORPORATION, ARMONK, NY (US)

(21) Appl. No.: 10/199,277

(22) Filed: Jul. 18, 2002

(51) Int. Cl. G06F 3/00

(52) U.S. Cl. 710/19

(57) ABSTRACT

The present invention is implemented in the context of a system that monitors the statuses of devices that operate in a network environment such as a physical facility from a central location. In this system, there is a depository of the status of all designated device attributes of a device including the past state history of the device. Each device on the system will transmit a state change notification to the central location each time the status of the device changes. In the process of the present invention, the central manger installs a publish routine on the newly added device to the network that would enable the device to asynchronously transmit to the state manager a status change each time a status change occurred with the device. A status change can be defined by a change in any one parameter or a combination of parameters. This status change will be recorded in a storage location for particular device.

### FIELD OF THE INVENTION

This invention relates to a method for reporting the status of a device and in particular to a method for enabling a device to report to a state manager a change in the status of the device each time a status change occurs in the device and without receiving a device status inquiry.

### BACKGROUND OF THE INVENTION

Automation systems are used to control the behavior of an environment such as an industrial plant, an office building or a residential dwelling. Currently there is an increasing trend to automate various activities and task in our society. Industries such as the banking industry, the automotive industry, the oil and refining industry and transportation industry use computers and automation to control machines and other various devices during the performance of many tasks and processes. The application of automation control systems has expanded from large industries to small businesses and residential homes.

Home automation systems, or home management systems as they are sometimes called, commonly provide for control of lighting, heating and air conditioning, window shades or curtains, pool heaters and filtration systems, lawn sprinklers, ornamental fountains, audio/visual equipment, and other appliances. Home automation systems are frequently integrated with a home security system so that when a fire alarm is raised, for example, internal and external lights will be turned on. Security systems frequently include lighting control and other types of home automation as an option. Many larger homes incorporate a home theater that requires a certain amount of automation for convenient operation and this automation is often extended to other parts of the dwelling. In farms, the automation system will also control outbuilding heating and lighting and warn of abnormal conditions in automated feeding machinery and other equipment.

One form of automation system includes a central control unit that monitors environmental sensors and inputs from user controls and maintains a schedule of preprogrammed time-of-day and day-of-the week events. Inputs to the central control are provided by dedicated low-voltage wiring, for example, from door and window sensors, signals carried on power lines, RF signals, signals on existing telephone wiring and, occasionally, optical signals. The central control unit is controlled by a program that is either specifically built for the particular installation or a general-purpose program with a user interface that allows the owner or a technician employed by the owner to make certain types of modifications. The interfaces to these programs can be anything from strings of digits entered on standard touch-tone keypads, for example, Home Automation Inc.'s Omni Automation and Security System, to graphical user interfaces, for example, the Molex “Choices” software.

The communication between the central control unit and various devices can be through a variety of protocols. The Echelon Corporation has built home automation and industrial control apparatus based on a signaling protocol they refer to as LonWorks that uses a network of nodes each of which has one or more microprocessors. The system is designed to operate in a “cooperative computing” environment in which the individual nodes maintain their own programs. Programming of the individual nodes can be done by downloading new software from a temporarily attached lap top computer or by downloading software over the LonWorks network. A similar approach has been taken by CEBus and has been used in many custom installations for larger homes and office buildings. While such systems eliminate the central control unit, modifying the software still requires the use of a PC-based system and usually requires the user to acquire relatively expensive hardware and software and become proficient in the use of PC-based software.

The latest internationally accepted standard for residential communication is the Consumer Electronics Bus (CEBus). The Media used in a CEBus Network topology can vary between power-line wiring (PL), telephone wiring (TP twisted-pair), coaxial cable (CX), RF (radio frequency) and the like. It provides the standard for creating products and devices to communicate with each other, and should build intelligence into homes or any physical or virtual facility with smart products (aggregation of smart devices) in anticipating tomorrow's consumer needs. Though the intent of the original specification was directed at the residential market, the inventions disclosed here by its three inventors have envisioned a much more extensive application uses. The consumer can be any person, a firm, government agency, whatever or whomever has a need to communicate to smart devices.

The official name for CEBus standard is ANSI/EIA 600. At the core of the standard are the CAL (Common Application Language) and the Application Layer. It provides the basis of the interoperability between CEBus compliant devices and a transport independent version (Generic CAL) (Generic CAL) ANSI/739 that an integral part of the Home PnP (Plug and Play) ANSI/721 specification (which defines how networked products of various manufactures achieve interoperability regardless of the communication protocol used (CEBus, X-10, RS-232, IEEE-1934, TCP/IP etc.)

The devices that utilize these standards contain context data structures. Each CAL Context is a predefined data structure built from reusable objects, and represents a common consumer product function such as a tuner, time or temperature sensor. These context data structures are defined in a set of subsystems definitions that represent industry standard guidelines that define the behavior of the device, which is necessary to enable products to correctly use the subsystem models.

In a home, there are many appliances and devices that are powered by electricity, either AC or DC. At the present time, there is no standard method to keep track of the current state of each device. The state attributes could be for example ‘on’, ‘off’, ‘channel’, ‘temperature’ etc. Currently some devices have a means to report information back to the manufacturer of the device activities of the device through proprietary channels, however there is no way currently for the various devices to communicate with each and no way for the homeowner to receive this type of status information.

Devices can be easily added to the system using conventional Plug and Play techniques. These techniques enable a system to perform system reconfigurations to accommodate the addition of new devices to the system. The newly added devices typically announce their presence on the system and then the system reconfiguration techniques adapt the system such that the newly added device can operate with minimum concern for system compatibility concerns. However, not all devices are added to systems utilizing that process. CEBus compliant devices are not required to announce their presence when added to the network. In order to learn of the addition of a device, a polling procedure occurs to detect and identify any newly added devices. This polling procedure also occurs in order to get device status information. The devices in these systems are polled periodically to determine their status condition. A status inquiry is sent to a device and the device then responds with its current status. This method is severely limited when a system have a large number of devices.

It is desirable to provide an automation system that has a central control unit that can enable various devices on the same system to communicate their status to the central control unit each time there is a status change at the device. In addition it is desirable to have a method that is an event driven announcing of device identification when the device is first initialized on the network. It is also desirable to have a method in which the device status information is asynchronously communicated to the central control without a status inquiry from the central control. These methods would minimize the frequency of polling devices to maintain device status information.

### SUMMARY OF THE INVENTION

It is an objective of the present invention to provide a method for gathering the status of a device each time there is a status change of the device.

It is a second objective of the present invention to provide a method that can enable a device to report a status change to the device without initially receiving a status inquiry.

It is a third objective of the present invention to provide a set of instructions that will enable a device to report a status change to the device whenever their a status change at the device without receiving a status change inquiry.

It is a fourth objective of the present invention to provide a method to transmit to and install in a device a set of instructions that will enable a device to report a status change to the device whenever their a status change at the device without receiving a status change inquiry.

It is a fifth objective of the present invention to provide a method obtaining device status information that will substantially reduce the need to poll devices in order to get the device status information.

The present invention is implemented within the context of a method and system that monitors and manages the statuses of devices from a central location. This system provides a repository of the operating history of a device including a device status each time a defined device attribute changes.

In this invention, each device on in a system is in communication with a state manager process. Within this system, the status of each device is recorded each time a defined device attribute changes. The status is any current state of a device and can have one general attribute or multiple attributes. An example of a device is a videocassette recorder. The status could be one attribute such as “off” and “on” or multiple attributes such as off, on, start, stop, rewind, record, pause, program or channel. For a multiple attributes device, a change in any attributes would constitute a change in the device status. When this change occurs, the device would transmit the change to the state manager. This change in status would be stored as the current status of the device.

In the method of the present invention, each new device added to a network would have a device identification number. At this point, the central manager installs a status reporting routine on the newly added device that will enable the device to asynchronously transmit to the state manager a status change each time a status change occurs within the device. In this process, instructions, referred to herein as a status reporting routine, are installed on one of the communication layers of the device. This installed routine will cause the device to report its status each time there is a status change of the device. By installing this status reporting routine in the device, the status reporting operation of the device changes. The conventional operation is for the device to report a device status in response to a status inquiry. With this status reporting routine, the device will report a status each time there is a status change in the device. A status change can be defined by a change in any one device attribute or a combination of attributes. The status reporting routine is an in-memory agent, which detects device variable changes and reports these changes to the state manager. When a status change occurred in a device, that device would transmit the change to the state manager for recording and storage in the central repository location for that device.

### BRIEF DESCRIPTION OF THE DRAWINGS

FIG. 1 is a configuration of components in a physical facility that implements the method and system of the present invention.

FIG. 2 represents the application of the present invention to a thermostat system.

FIG. 3 illustrates a state diagram showing the state management of a CAL message compliant device.

FIG. 4 is an illustration of a CEBus model.

FIG. 5a is an illustration of the ISO System model that represents a conventional standard of communication.

FIG. 5b shows the internal structure of the CEBus communication model.

FIG. 6 is a flow diagram of the steps in a method for monitoring and recording the operating statuses of devices on the network.

FIG. 7 is a flow diagram of the steps in a method of the present invention.

### DETAILED DESCRIPTION OF THE INVENTION

The present invention is implemented in the context of a method and system to collect a unique set of data containing the operations of a device over a period of time. This system is described in a co-pending patent application number AUS920020055US1 assigned to the same assignee as this application and is incorporated by reference herein. In order to clearly illustrate the techniques in this invention, the description of this invention will be in the context of an application in a physical facility. However, the application of this invention encompasses applications in addition to the physical facility environment described herein. The present invention has the capability to monitor and manage the statuses of devices that operate in a physical facility from a central location. The physical facility can vary and can be for example a business, a factory, a computing center, a distributed network of devices, or satellites orbiting in space. The implementation of the present invention does not need to be configured as a centralized control contained within a building structure. For example, the facility can be a home is using the latest internationally accepted standard for residential communication (which in this example is the Consumer Electronics Bus (CEBus)), In this home the State Management repository will hold persistent all state information of all compliant devices. For example, for a radio device, the repository will capture data that comprise the present and past state of the radio, how long it has been on, its tuned broadcasting frequency, its volume level, the time it was tuned to that particular station, the station it was tuned to previously, and the time it was tuned to that previous station. For a different device, the system will also capture the status of the smoke detectors in the house, whether they are operable, if they need maintenance, when each detector was last activated, and the amount of time they were active. The State Management repository of the present invention can also capture anyone or any device trying to gain electronic access to devices in this facility, the time of the attempted access, the purpose of this access, and the origin of this access attempt This data can remain in the persistent store for the life of the device, the life of the home, or a predetermined time period established by the owner.

The communication with all compliant devices in this CEBus Network topology can use any or all of the following mediums; power-line wiring (PL), telephone wiring (TP twisted-pair), coaxial cable (CX), RF (radio frequency) and other similar transmission mediums. The present invention provides the standard for creating products and devices to communicate with each other, and build intelligence into homes or any physical or virtual facility with smart products (aggregation of smart devices) in anticipating the needs of tomorrow's consumer. The present invention has applications in various segments of society, which include individual consumers, a business, a firm, or governmental agency.

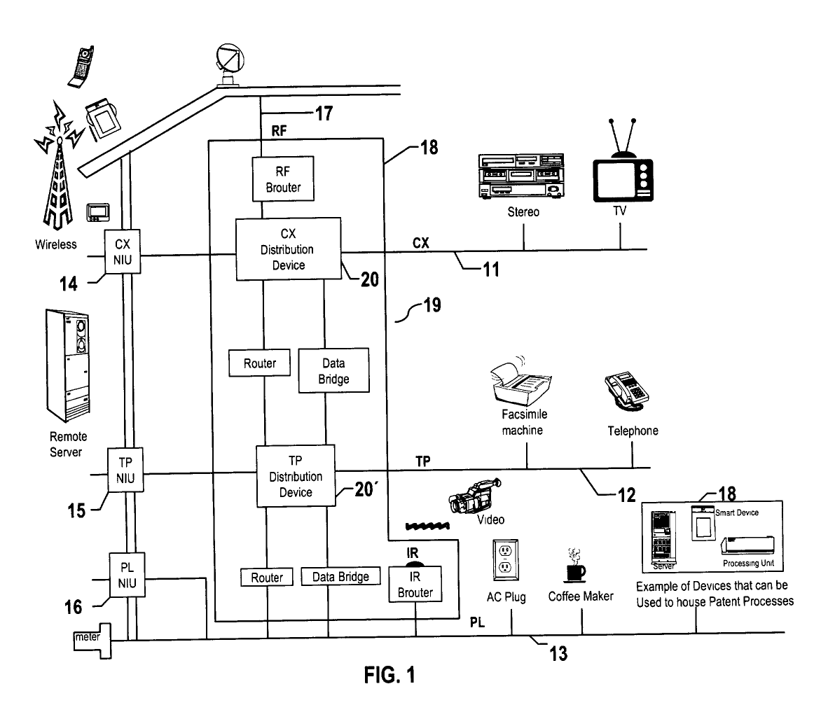

FIG. 1 is a configuration of components in the system of the present invention. In this configuration lines 11, 12 and 13 are various ways that information and energy can enter a facility to enable operations of the devices in the facility. Line 11 represents communications over a coaxial cable through a device such as a television set. Line 12 represents communications over twisted pair cables through a device such as a telephone. Line 13 represents the supply of energy through a standard power line wired into the facility to operate devices and appliances in the facility such as a coffee maker. These communication lines are physical and therefore have a physical entry into the facility. The physical entry points for the coaxial cable, twisted pair and power lines are represented by NIU boxes 14, 15, and 16 respectively. Also shown is an input medium using radio frequencies (RF) 17. Devices that communicate through this medium are remote devices/wireless devices that include devices such as cellular telephones. In the present invention, there would be a status of each device in facility regardless of the manner in which the device is powered or the manner in which the device communicates. The center of activity is the state manager 18, which is a process that captures status information for the various devices and coordinates communications between the various devices in the facility. In addition, this state manager, using industry standard format, provides persistence to a data store and can transmit data to any device in the facility. Section 19 illustrates bridges and routes that provide communication links between the incoming information lines (11, 12, and 13), the distribution devices 20 and 20′ and the appliance devices.

As previously mentioned, the devices that utilize the CEBus standards contain context data structures. Each CAL Context is a predefined data structure built from reusable objects, and represents a common consumer product function such as a tuner, time or temperature sensor. These context data structures are defined in set of subsystems definitions that represent industry standard guidelines that define the behavior of the device. These guidelines are necessary to enable products to correctly use the subsystem models.

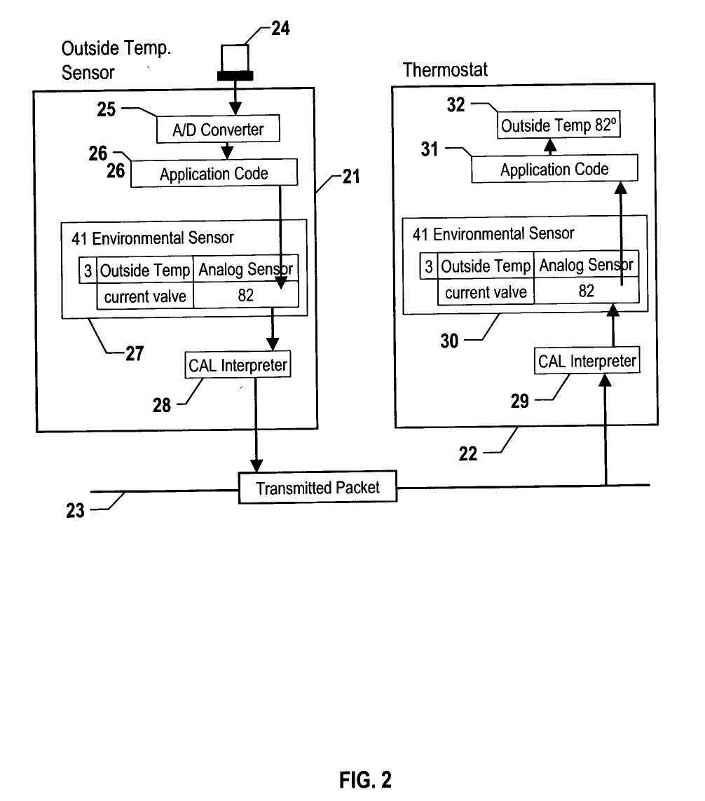

FIG. 2 shows two different devices that communicate with each other using this CEBus network topology standard. One device is an outside temperature sensor 21, the other being a thermostat 22. Both devices store within their solid-state memory context data structures, in which contain different attributes and their values. The sensor and thermostat can communicate with the central control section over a transmission bus 23. The outside temperature system comprises an actual sensor 24 that detects the current outside temperature. This sensor sends an analog signal of the measured to temperature to an A/D converter 25 that converts the signal to digital form. The application code box 26 processes this signal and sends it to a display 27. This application code box 26 contains standard software that can exist on any device. The use of a Consumer Electronic Bus (CEBus) protocol allows for application software to reside on each device. Box 27 displays the current temperature measured by the sensor 24. The Common Application Language (CAL) interpreter 28 receives this measurement and transmits the information via the transmission bus 23 to the state manager 18. The CAL interpreter parses and understands the message format and the transmitted packet represents a communication link between the two devices. This information would be recorded for the temperature sensor in the storage section each time the temperature sensor detected a change in temperature. The internal thermostat 22 contains a Common Application Language (CAL) interpreter 29 to facilitate communication via the transmission bus 23 with the central control section. Also contained in the thermostat is a temperature display 30 similar to the display 27 in the outside temperature sensor 21. Application code 31 puts the temperature information in a form for the temperature display 32. In accordance with the present invention, upon receiving the change in temperature notification from the temperature sensor, the central control section can send a temperature change notification to the thermostat of the new sensed temperature. The thermostat can then adjust the room or facility based on the new sensed temperature. This thermostat change will then be sent to the central control section and recorded as a change in status of the thermostat.

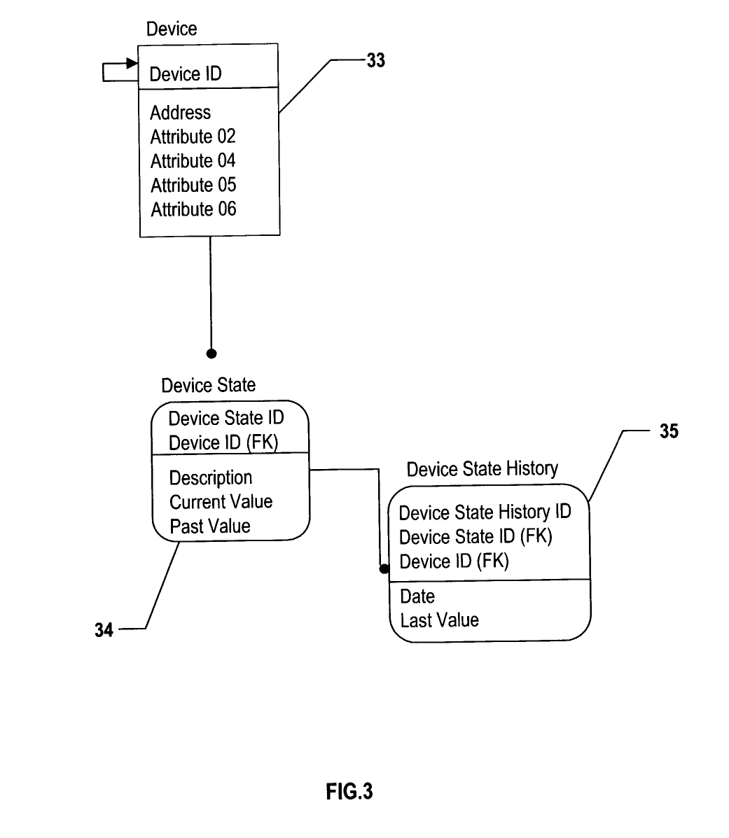

FIG. 3 illustrates a process and data flow model of a device state management system of the present invention. It maintains state (status) information of all devices, sensor and components that it can communicate on the system. This model provides the basis and core of sub systems status (state), transition and event driven based decision-making operation. It maintains current status of devices and it's past state history. It also offers the capacity to reset status in the event of an interruption in power or reversing an updating entry. The names chosen in this model exemplify distinctly what the process flow represents. Regardless, if the entities and its attributes are renamed or represented in a de-normalized fashion. The effect of the model is the same. The device 33 comprises attributes that define it current data values, and primary event driven operations. Devices can also be an aggregation of smaller devices (i.e. sensors, components, etc.) The device has a Unique Identifier and sensor(s) or component(s) that are aggregated make up that device [i.e. a thermal sensor, and a Thermostat (consists of thermal sensor, LED display etc.) are both considered devices. Though one attribute may be part of the composition of another.] The device state 34 represents current status configuration of the device. This device state comprises: 1) Device State ID—Unique identifier of the specific status state it references, 2) Description—Clear Definition of the State that is identified by the Device State ID, 3) Current Value—Current Status value of the device and 4) Past Value—Previous Status vaue of the device. The Device State History 35 contains the history of pass values per device which include: 1) Date—Date of historical record and 2) Last Value—last value recorded on that date

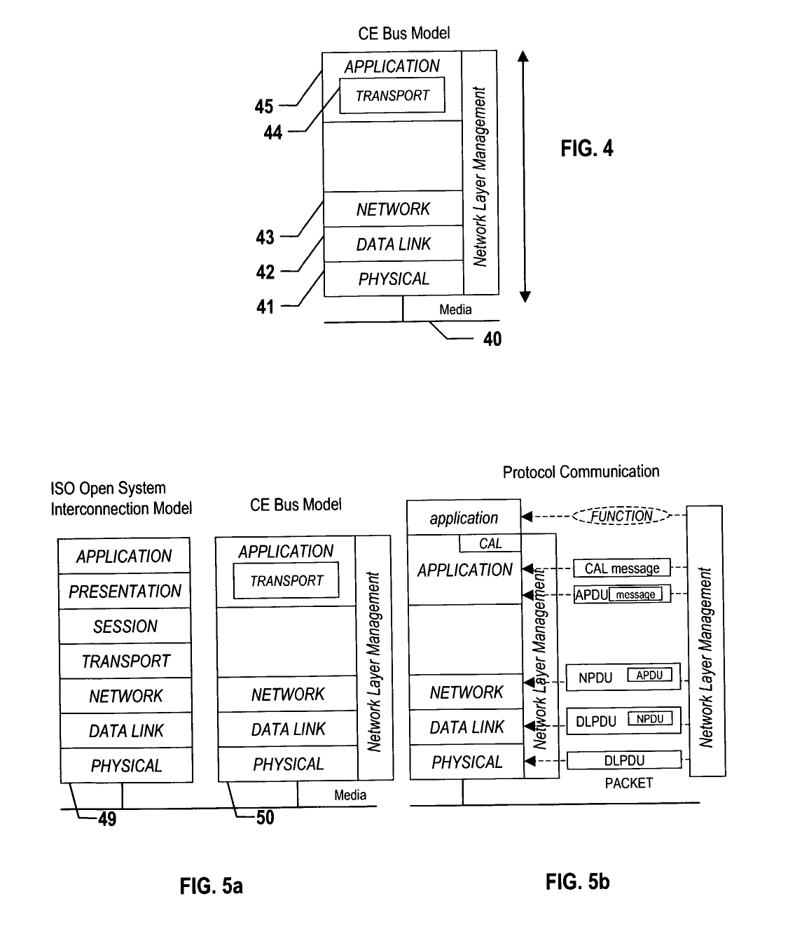

FIG. 4 is an illustration for the purpose of example of the Consumer Electronic Bus) CEBus Layered Model. It is a standard, much like the OSI (Open Systems Interconnection) Model, in that it illustrates the layer of communication from the physical layer (via physical connection to a media source) up the logical layers above the previous layer (via the network management) to the top level application layer into an application that makes sense of the information being transferred. Smart embedded devices in the Consumer Electronic Industry follow this standard. In fact many devices do not need to contain all logical levels within themselves within a single chip or component. The different required layers can span over components before the physical layer connects to a network medium.

At the core of the standard are the CAL and the Application Layer. It provides the basis of the interoperability between CEBus compliant devices and the transport independent version (Generic CAL0 ANSI/EIA 739 that is an integral part of the Home PnP (Plug and Play) ANSI/EIA 721 specification (which defines hoe networked products of various manufactures achieve interoperability regardless of the communication protocol used (CEBus, X-10, RS-232, IEEE-1394, TCP/IP etc.).

In this model, shown in FIG. 4, media 40 represents the wiring going out from the model. The physical layer 41 is the connection of a device to an electronic network. The data link layer 42, network layer 43, transport layer 44 and application layer 45 represent a standard of how information is communicated from a physical device down to logical data that is traced back to an application that talks to that model.

State management can be maintained anywhere even remotely since the CEBus Model can share a common connection with the ISO across disparate physical media. Regardless of the communication protocol used across the gateway, the receiving end needs only to understand the communication protocol and be able to interpret the data packets sent across the network. FIGS. 5a and 5b illustrate how communication can be bridged between the CEBus and the OSI Model, via a connected medium. The connected medium does not necessary have to be the same wire it can represent any other available connection means. These figures represent the two standard models interconnected, and communicating with each other. This illustrates how far reaching the scope of the state management is, and that it can incorporate any device that it has a connection to. The figure represents only two types of models, however the number of interconnected models, are not limited. It can involve any interconnections that can be accomplished between different models and their supported interconnected networks, as long as communication is allowed to flow to the state management system (model represented by FIG. 3).

As illustrated in FIG. 5a, the ISO System model 49 represents another conventional standard for communication. This model has seven different layers of communication. The CEBus model 50 has a different layer structure than the ISO model. However, down at the physical layer, the models are the same. The common physical layer provides the common interface for the models to communicate with each other through the media.

FIG. 5b shows the internal structure of the CEBus model. In this configuration information comes into the model through the different layers. The Common Application Language (CAL) is an interpreter that parses information and data containing status messages coming into the model to appropriate applications and enables those applications to use that data. This diagram shows how information can go from a physical to a logical type of interpretation.

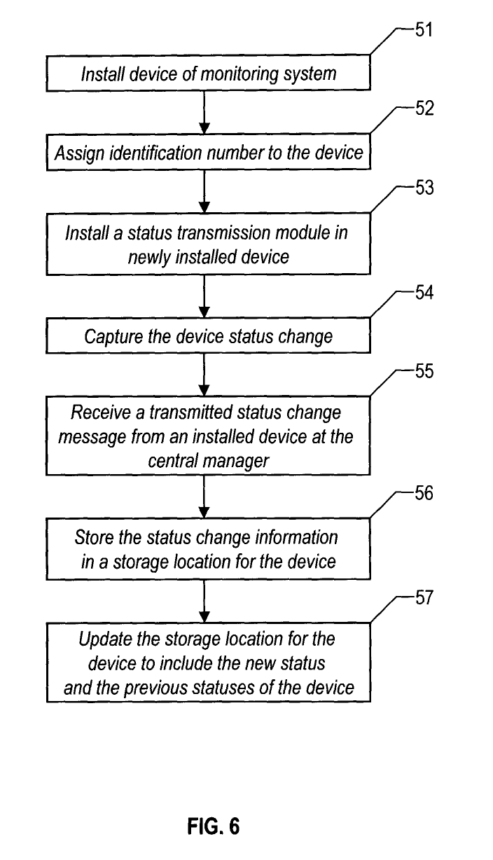

FIG. 6 is a flow diagram of the steps in the method of the present invention. The initial step 51 is to install a new device on the status monitoring system. The installation requires connecting the device to a communication link such as coaxial cable or twisted pair cable. Also in this installation step, the state manager 18 sends notice of a new device. After this notice, in step 52, the central manger assigns an identification number to the device. In the alternative, a particular device may have an identification number assigned to it during the manufacturing process by the manufacturer. In this case, the process will simply record the previously assigned device identification number. In step 53, the state manager 18 transmits a status transmission model in the form of a device status reporting routine to the device that is automatically installed in the device. This model will access the attributes of the device and determine the various statuses and the criteria that will constitute a status change. These criteria can also be determined externally by a user and can override any criteria of the model. After the device installation phase, the central control is in a wait state for a change in status message from the device 54. The initial state of the device can be a default of “off”. When there is a change in the status of the device, the device will transmit a change in status message to the central controller as shown in step 55. This message should contain the particular attribute or set of attributes that changed status and the new status of the device. The state manager 18 will identify the particular device and store this current status information in the location for that device in step 56. The central controller will also maintain the previous status of the device in the storage area for that device 57.

Referring to step 53, the present invention is a detailed description of the techniques in the installation and implementation of this status reporting routine. As mentioned, CEBus devices currently are not required to report their current operating status. If a CEBus device did report its status it would only report it to the manufacturer. In this process, instructions, referred to herein as a status reporting routine, are installed on the application of the device that will cause the device to report its status each time there is a status change of the device. By installing this status reporting routine in the device, the status reporting operation of the device changes. The conventional operation is for the device to report a device status in response to a status inquiry. With this status reporting routine, the device will report a status each time there is a status change in the device. The status reporting routine is an in-memory agent, which detects device variable changes and reports these changes to the state manager 18.

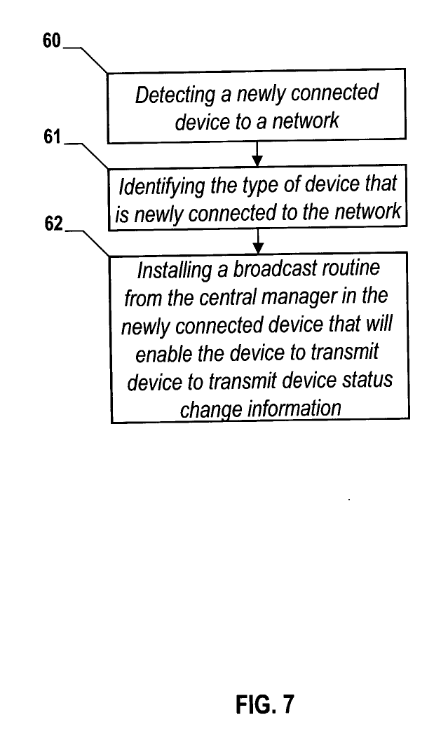

FIG. 7 illustrates the general steps in the implementation of the method of the present invention. Step 60 is a network step in which the network is monitored for changes to the network configuration. In this operation, one of the tasks of the network is to detect when a new device has connected to the network. When to network detects a new device, step 61 begins the process of identifying the type of device that has connected to the network. The device may receive an automatic prompt once it connects to submit device information to the network state manager 18. This information about the device could contain data on the communication configuration of the device such as illustrated in FIGS. 4 or 5. Once the communication configuration of the device has been identified, step 62 installs the status reporting routine in the device in the appropriate application layer. This layer is usually the application layer as identified in FIG. 4. The installation of the status reporting routine usually comprises steps of transmitting the routine from the network state manager 18 to the newly connected device and writing the routine into the application layer of the device such that the device will report status changes asynchronously and without being prompted from the state manager 18.

In addition, when a device is added to the interconnected networks, the state management stores the current state of the devices attributes. When the status of the device changes, the changed attributes updated are reflected within the state management system. The previous record is then store in the devices state history. This provides devices, products and smart applications, a common interface to inquire and use any derived intelligence in applying this acquired information. It also enables connected devices to recover to a previous state or reset devices to present state in the event of a power outage.

The present invention is implemented within a method and system that collects a unique set of data containing the operations of a device over a period of time. The nature of the application of the present invention is such that various configurations of this invention can be implemented under the same concept described herein. While the description herein is one embodiment of the invention, alternate embodiments can be designed by those skilled in the art that would also fall under the scope of the present invention. It is important to note that while the present invention has been described in the context of a fully functioning data communication system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

We claim:

1. A method for reporting the status of a device without receiving a status inquiry comprising the steps of:
detecting the installation of a new device on a monitoring system;
identifying characteristics about the device; and
installing in the newly installed device a set of instructions that will enable the device to report device status information each time there is a status change in the device without the report being a response to a device status inquiry.

2. The method as described in claim 1 wherein said identification step further comprises the step of identifying the various communication layers of a device.

3. The method as described in claim I wherein said identification step further comprises the step of identifying the attributes of the device that will impact the status of the device.

4. The method as described in claim 1 wherein said installation step further comprises the steps of:
transmitting the set of instructions to the device;
identifying the application of the device where the set of instructions will be installed; and
writing the set of instructions into the device in the identified application layer.

5. The method a described in claim 3 further comprising after said installation step, the steps of monitoring the identified attributes of the device that will impact a status change in the device and transmitting a device change status notification each time an attribute changes.

6. The method as described in claim 5 wherein said device change notification is transmitted to a state manager location.

7. The method as described in claim 5 further comprising the step of compiling the status change notification message for transmission that will include the current status of each designated device attribute.

8. A computer program product in a computer readable medium for reporting the status of a device without receiving a status inquiry comprising:
instructions for detecting the installation of a new device on a monitoring system;
instructions for identifying characteristics about the device; and
instructions for installing in the newly installed device a set of instructions that will enable the device to report device status information each time there is a status change in the device without the report being a response to a device status inquiry.

9. The computer program product as described in claim 8 wherein said identification instructions further comprise instructions for identifying the various communication layers of a device.

10. The computer program product as described in claim 8 wherein said identification instructions further comprise instructions for identifying the attributes of the device that will impact the status of the device.

11. The computer program product as described in claim 8 wherein said installation instructions further comprise:
instructions for transmitting the set of instructions to the device;
instructions for identifying the application layer of the device where the set of instructions will be installed; and
instructions for writing the set of instructions into the device in the identified application layer.

12. The computer program product a described in claim 10 further comprising after said installation instructions, instructions for monitoring the identified attributes of the device that will impact a status change in the device and instructions for transmitting a device change status notification each time an attribute changes.

13. The computer program product as described in claim 10 further comprising instructions for compiling the status change notification message for transmission that will include the current status of each designated device attribute.

14. A method for reporting the status of a device without the device receiving a status inquiry, said device being incorporated into a system that monitors and manages the status of devices from a central location and records an operational history of a device, and said status reporting method comprising the steps of:
detecting the installation of a new device on a monitoring system;
identifying characteristics about the device; and
installing in the newly installed device a set of instructions that will enable the device to report device status information each time there is a status change in the device without the report being a response to a device status inquiry.

15. The method as described in claim 14 wherein said identification step further comprises the step of identifying the various communication layers of a device.

16. The method as described in claim 14 wherein said identification step further comprises the step of identifying the attributes of the device that will impact the status of the device.

17. The method as described in claim 14 wherein said installation step further comprises the steps of:
transmitting the set of instructions to the device;
identifying the application layer of the device where the set of instructions will be installed; and
writing the set of instructions into the device in the identified application layer.

18. The method a described in claim 16 further comprising after said installation step, the steps of monitoring the identified attributes of the device that will impact a status change in the device and transmitting a device change status notification each time an attribute changes.

19. The method as described in claim 18 wherein said device change notification is transmitted to a state manager location.

20. The method as described in claim 18 further comprising the step of compiling the status change notification message for transmission that will include the current status of each designated device attribute.
